(19) United States
(12) Patent Application Publication
(10) Pub. No.: US 2006/0123413 A1
(43) Pub. Date: Jun. 8, 2006

(54) System and method for installing a software application

(75) Inventors: Jean-Luc Collet, La Gaude (FR); Beatrice Coulomb, Cagnes sur Mer (FR); Sophie Martin, La Gaude (FR); Carole Truntschka, Saint-Laurent-Du-Var (FR)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/287,975

(22) Filed: Nov. 28, 2005

(30) Foreign Application Priority Data
Nov. 30, 2004 (EP) 04300826.7

(51) Int. Cl. G06F 9/445

(52) U.S. Cl. 717/174

(57) ABSTRACT

A method is provided for detecting and storing all the actions performed, and modifications made to the Windows Registry and file system of a first computer, during the installation of a software application thereon. The data are collated into a single package for subsequent export to a second computer. On receipt of the package by the second computer the process of installing the software application is re-enacted on the second computer using the data stored in the package.

### TECHNICAL FIELD

The present invention relates to a system and method for installing a software application from a first computer to another computer.

### BACKGROUND

When a user replaces a computer with a new computer, the user typically has to spend a considerable amount of time installing the software that existed on the previous computer onto the new computer. Similarly, when a user updates the operating system of a computer, the updating process occasionally damages the applications previously installed on the computer. As a result, the user must spend a considerable amount of time re-installing the lost or damaged applications.

This problem is magnified for network administrators or other IT professionals who typically have to manage and maintain a large number of computers. In particular, an IT professional may have to spend several days re-installing software onto computers after an operating system update.

While the above installation process is time-consuming and tedious, nonetheless it is comparatively straightforward if the installation software for the required application is readily available. However, if the installation software has been lost, the user must contact the original software supplier to request a replacement copy of the software, before the required application can be re-installed. This introduces a delay into the re-installation process, as the user awaits a response from the software supplier.

If the software supplier maintains a secure download Internet site, the user could avoid the above problem by downloading the required installation software from the site. However, the process of acquiring portal access to the supplier's server also introduces a delay into the re-installation process (albeit considerably reduced compared with the above process of contacting the supplier to request a replacement copy of the software).

Under the Microsoft® Windows® operating system, the process of installing a new software application onto a computer causes modifications to be made to the file system of the computer by copying files into the file system and/or user defined folders. The process of installing the new software application also causes modifications to be made to the Windows® Registry of the computer.

The Windows® Registry is a central hierarchical database which replaces most of the text-based .ini files used in Windows 3.x and MS-DOS (e.g., Autoexec.bat and Config.sys). More particularly, the Windows® Registry stores configuration information including:

(a) user profiles;

(b) profiles of the applications installed on the host computer (including license details and operational parameters thereof) and the types of documents that each application can create;

(c) property sheet settings for folders and application icons; and

(d) details of the hardware connected to the host Computer.

U.S. Pat. No. 6,032,201 describes a “plug and play” system using a proxy to retrieve information about a currently installed device. However, the invention described in U.S. Pat. No. 6,032,201 manages modifications made to the host computer's .ini files rather than the Windows® Registry. Furthermore, the invention described in U.S. Pat. No. 6,032,201 is limited to managing the installation of hardware devices rather than the process of software installation.

### SUMMARY OF THE INVENTION

The present invention is directed to a method, system and computer program for installing software on a remote computer without access to a software installation program.

The present invention provides a mechanism for detecting and storing all the actions performed during the installation of a software application onto a first computer. The present invention also provides a mechanism for detecting and storing all the modifications made to the file system of the first computer during the installation of the software application thereon.

In particular, the present invention acquires and saves the following data during the installation of a software application onto a first computer:

(a) all the files related to the software application (e.g., DLL, executable and data files);

(b) details of all the actions performed during the installation of the software application (e.g., updates to the registry, PATH etc.);

(c) the license number of the software application; and

(b) the license number of the software application's uninstallation/installation manager.

The present invention collates all of the above data into a single package for subsequent export (possibly through the Internet) to a second computer (or to a plurality of second computers). On receipt of the package by a second computer, the process of installing the software application is replayed on the second computer using the data stored in the package. The above system and method can be extended for use in a networked environment wherein all the core files (and details of actions performed during installation) of a software application are installed and stored as a package in a shared file system resource for subsequent export and installation onto a plurality of local computers. This greatly reduces the administrative and technical burden of managing software installation on a plurality of local computers, since only system and location settings need be installed on each local computer. This contrasts with the traditional mechanisms for software installation in which it is necessary to install all of the files of the required software application onto each local computer.

However, it should be noted that for the installation system and method of the present invention to operate as described above, both the first and second computers must employ the same version of a Microsoft® Windows® operating system.

Definitions

For the sake of brevity, the actions performed during the traditional process of installing a software application onto a computer (i.e., installation directly from an installation program) will be referred to henceforth as installation actions.

The computer onto which a software application is installed using a traditional installation process will be known henceforth as a donor computer. The computers onto which the software application is installed using the installation system and method of the present invention will be known henceforth as recipient computers.

### BRIEF DESCRIPTION OF THE DRAWINGS

An embodiment of the invention will now be described with reference to the accompanying drawings in which:

FIG. 1 is a block diagram of a system for installing a software application in accordance with the invention, in use between a donor computer and a recipient computer;

FIG. 2 is a flowchart of the steps of a method of installing a software application in accordance with the invention, performed in a donor computer; and

FIG. 3 is a flowchart of the steps of a method for installing a software application in accordance with the invention, performed in a recipient computer.

### DETAILED DESCRIPTION OF THE INVENTION

1. Overview

The present invention is based on a daemon which tracks all the modifications made to a donor computer during the installation of a software application thereon. The daemon stores the modifications as a list of installation actions and files associated with the installation actions (and/or other specific alteration details). This list enables the relevant files to be copied or moved to recipient computers and the stored modifications to be applied thereto, so that the software application may be automatically deployed on the recipient computers without recourse to an original installation program.

The present invention is designed for computers employing an operating system selected from the Microsoft® Windows® family. Since the process of installing a software application onto any such computer causes modifications to the computer's file system and Windows® Registry, the present invention focuses on coordinating the detection and storage of these modifications, so that they may be exported to other computers employing the same operating system.

2. Detailed Description of the Installation System

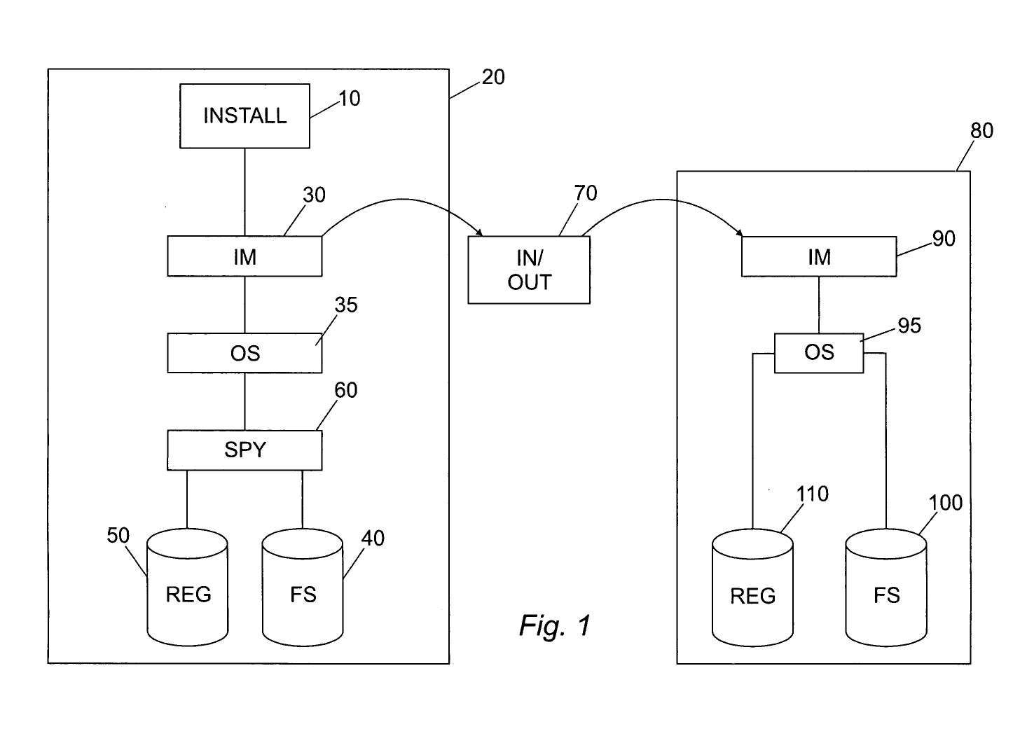

Referring to FIG. 1, an application installation program 10 is a program that resides on a donor computer 20 and mediates the process of installing a software application (not shown) onto the donor computer 20.

On receipt of a user request (not shown) for the installation of a software application onto the donor computer 20, a spy daemon known as the installation manager 30 is activated. It is only after the installation manager 30 has been suitably initialised that the application installation program 10 is activated. Once the installation manager 30 has been initialised, a spy module 60 logs all the modifications made by the application installation program 10 to the file system 40 and the Windows® Registry 50 of the donor computer 20.

Once the required software application has been successfully installed onto the donor computer 20, the installation manager 30 creates a package 70 comprising the following data:

(a) details of all the installation actions performed during the installation of the software application;

(b) details of the files on which the installation actions were performed; and

(c) details of the modifications made to the donor computer's file system 40 and Windows® Registry 50 during the installation of the software application.

The package 70 can then be exported to a recipient computer 80 by means of an installation manager daemon 90 residing on the recipient computer 80. In particular, the package 70 is parsed by the recipient computer 80 and all the installation actions and modifications stored in the package 70 are re-enacted onto the file system 100 and the Windows® Registry 110 of the recipient computer 80. As a result, the original software application is effectively installed onto the recipient computer 80 without requiring the presence of the application installation program 10 therein.

It will be understood that for the installation system to operate as described above the donor computer 20 must be employing an operating system 35 whose version is the same as the operating system 95 of the recipient computer 80.

3. Detailed Description of the Installation Method

(a) Steps of the Installation Method Performed in a Donor Computer

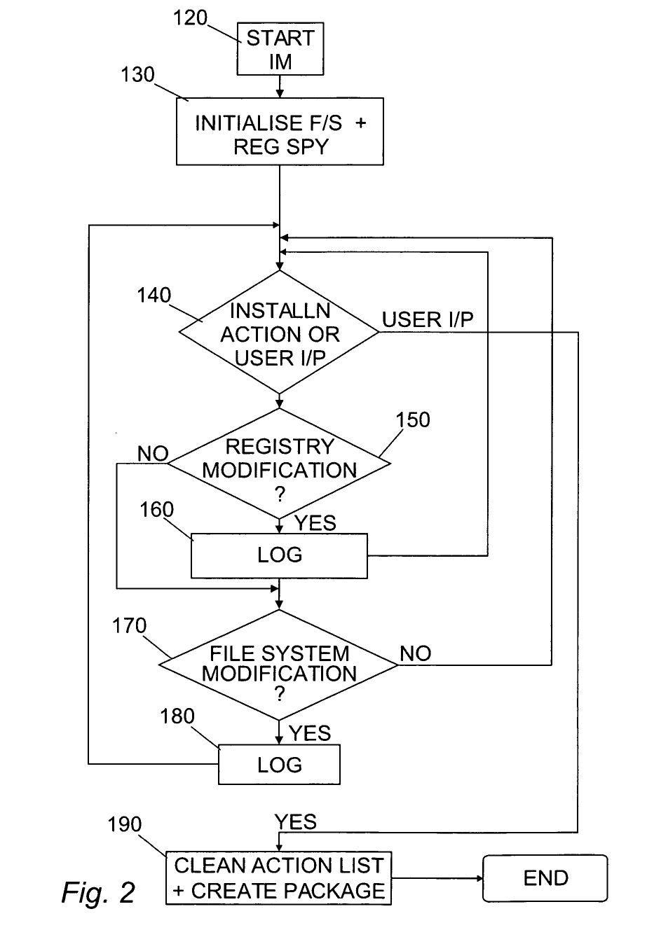

Referring to FIG. 2, the installation method commences when the user starts the installation manager 120. This causes the initialisation of the installation manager and the file system/Windows® Registry spying daemon 130. If the spying daemon detects an installation action or modification made to the donor computer's file system or Windows® Registry during the subsequent installation of the required software application (not shown), the spying daemon flags the fact to the installation manager as a spy module event. Accordingly, once the installation manager has been initialized, it remains dormant, awaiting 140 the flagging of a spy module event or an indication from the user that the installation of the required software application has been completed.

If the spy module event flags 150 that a modification was made to the donor computer's Windows® Registry, the installation manager logs 160 the modification in an Action List. Alternatively, if the spy module event flags 170 that a modification was made to the donor computer's file system, the installation manager logs 180 the modification in the Action List. The above steps of checking spy module events and logging the associated modifications are repeated until the user indicates that the installation of the required software application has been completed.

Returning to step 140, if the user indicates that the installation of the required software has been completed, the installation manager cleans 190 the Action List. The cleaning process involves the replacement of all donor computer-specific system variables in the Action List with more generic variables. For example, the string C:\DOCUME˜1\ADMINI˜1\LOCALS˜1\Temp could be replaced with <% TEMP %> Windows®.

The list of Windows® variables in the Action List can be obtained using the set command as follows:

C:♯Documents and Settings♯Administrator>set
ALLUSERSPROFILE=C:♯Documents and Settings♯All Users
APPDATA=C:♯Documents and Settings♯Administrator

♯Application Data

CLASSPATH=.;

C:♯Program Files♯SQLLIB♯java♯db2java.zip;
C:♯Program Files♯SQLLIB♯java♯runtime.zip;
C:♯Program Files♯SQLLIB♯bin

CommonProgramFiles= C:♯Program Files♯Common Files
COMPUTERNAME=LGE-99VYN02
ComSpec=C:♯WINDOWS♯system32♯cmd.exe
DB2INSTANCE=DB2
DB2TEMPDIR=C:♯Program Files♯SQLLIB
HOMEDRIVE=C:
HOMEPATH=♯Documents and Settings♯Administrator
ICM_FOLDER=Information Catalog Manager
IMNINST=help
IMNINSTSRV=C:♯PROGRA˜1♯IBM♯IMNNQ

| | |
|---|---|
| INCLUDE= | C:♯Program Files♯SQLLIB♯INCLUDE; |
| | C:♯Program Files♯SQLLIB♯TEMPLATES♯INCLUDE |

LOGONSERVER=♯♯LGE-99VYN02
MDIS_PROFILE=C:♯Program Files♯SQLLIB♯METADATA♯PROFILES
NUMBER_OF_PROCESSORS=1
OS=Windows_NT

| Path= | C:♯PROGRAM FILES♯THINKPAD♯UTILITIES; |
|---|---|
| | C:♯WINDOWS♯system32;C:♯WINDOWS; |
| | C:♯WINDOWS♯System32♯Wbem; |
| | C:♯Program Files♯IBM♯Infoprint_Select; |
| | C:♯Utilities;C:♯Notes; |
| | C:♯Program Files♯IBM♯Trace Facility♯; |
| | C:♯Program Files♯IBM♯Personal Communications♯; |
| | C:♯Program Files♯SQLLIB♯BIN; |
| | C:♯Program Files♯SQLLIB♯FUNCTION; |
| | C:♯Program Files♯SQLLIB♯SAMPLES♯REPL; |
| | C:♯Program Files♯SQLLIB♯HELP; |
| | C:♯PROGRA˜1♯IBM♯IMNNQ; |
| | C:♯PSM;C:♯Infoprint; |

PATHEXT=.COM;.EXE;.BAT;.CMD;.VBS;.VBE;.JS;.JSE;.WSF;

.WSH

PCOMM_Root= C:♯Program Files♯IBM♯Personal Communications♯
PDBASE=C:♯Program Files♯IBM♯Infoprint_Select
PDHOST=
PD_SOCKET=6874
PROCESSOR_ARCHITECTURE=x86
PROCESSOR_IDENTIFIER=x86 Family 6 Model 9 Stepping 5,
GenuineIntel
PROCESSOR_LEVEL=6
PROCESSOR_REVISION=0905
ProgramFiles=C:♯Program Files
PROMPT=$P$G
SESSIONNAME=Console
SystemDrive=C:
SystemRoot=C:♯WINDOWS
TEMP=C:♯DOCUME˜1♯ADMINI˜1♯LOCALS˜1♯Temp
TMP=C:♯DOCUME˜1♯ADMINI˜1♯LOCALS˜1♯Temp
tvdebugflags=0x260
tvlogsessioncount=5000
USERDOMAIN=LGE-99VYN02
USERNAME= XXXXXXXXX
USERPROFILE=C:♯Documents and Settings♯Administrator
VWSPATH=C:♯Program Files♯SQLLIB
VWS_FOLDER=IBM DB2
VWS_LOGGING=C:♯Program Files♯SQLLIB♯LOGGING
VWS_TEMPLATES=C:♯Program Files♯SQLLIB♯TEMPLATES
windir=C:♯WINDOWS

The cleaning process ensures that the Action List is independent of system settings specific to the donor computer. Consequently, the Action List may be installed onto other computers with different system settings.

For example, on a first computer the windir environment variable can point to “C:\Windows” whereas on another computer, the same environment variable can point to “C:\Windows 2000”. By cleaning the Action List by retaining only the windir reference, the Action List and package derived therefrom, become independent of the physical system settings of the donor computer.

Once the Action List is cleaned, an installation package is created therefrom. The installation package also contains copies of the files associated with the installation actions/modifications contained in the cleaned Action List. On receipt of a command from the user, the installation package is transmitted to a recipient computer.

(b) Steps of the Installation Method Performed in a Recipient Computer

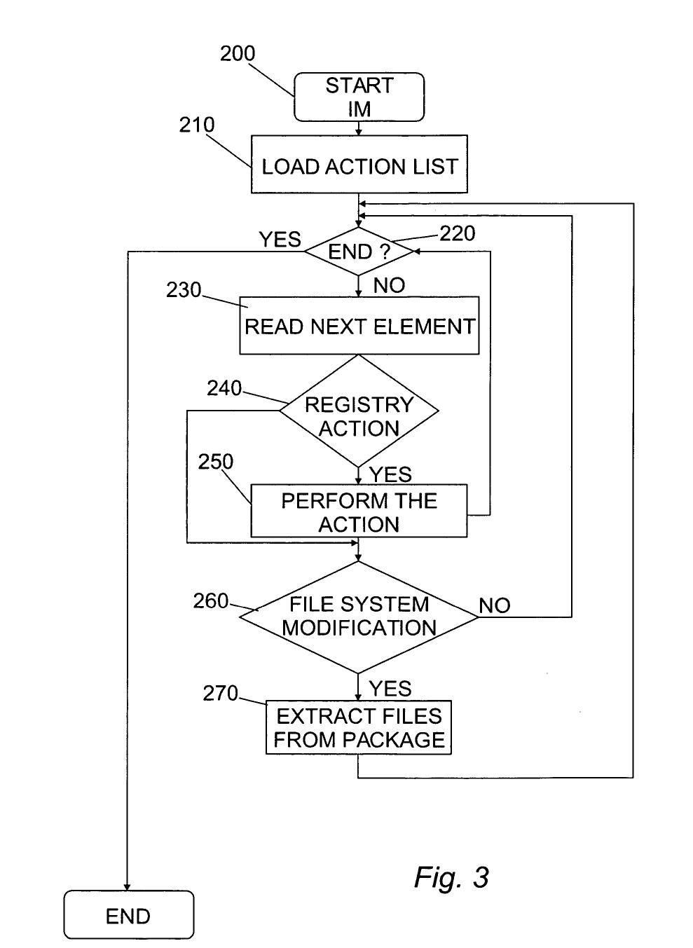

Referring to FIG. 3, on receipt of the installation package from the donor machine, the import manager on the recipient machine is activated 200. The Action List is extracted from the installation package and loaded 210 into the recipient computer. An element is read 230 from the Action List and if the element represents an action or modification to the Windows® Registry (of the donor computer) 240 the action is applied 250 to the Windows® Registry of the recipient computer.

However, if the element read from the Action List represents an action or modification to the file system (of the donor machine) 260, the action is applied 270 to the file system of the recipient computer by extracting the relevant files from the installation package to the recipient computer.

The above steps of reading elements from the Action List and performing the relevant corresponding actions/modifications are repeated until the end of the Action List has been reached at which point the installation process is terminated.

4. Hooking Mechanisms in the Installation Method

The installation method essentially relies on the detection and storage of actions/modifications made to the file system and/or Windows® Registry of a computer during the installation of a software application. A hook is a mechanism by which a program can intercept a piece of code during its execution. Accordingly, the installation method employs two different hooking mechanisms, namely file system hooking and Windows® Registry hooking. Both of these hooking mechanisms will be described in more detail below.

(a) File System Hooking

A software application can interact programmatically with the Microsoft® Windows® operating system through the Win32 API. Spying on the file system of a computer is part of the API provided by the Win32 API library.

The Win32 API provides various functions for directory management. The following functions are used for directory management in the Win32 SDK (C++) in the present installation system.

(1) FindCloseChangeNotification

(2) FindFirstChangeNotification

(3) FindNextChangeNotification

(4) ReadDirectoryChangesW

These functions respectively stop change notification handling; create a change notification handle; request that the operating system signal a change notification handle the next time it detects an appropriate change; and retrieve information describing the changes occurring within a directory. The C++ source code below provides an example of how to detect changes made to the “C:\Program Files” directory.

```
HANDLE file;
file = FindFirstChangeNotification
      (“c:♯♯Program Files”, FALSE, (DWORD),
      ((Param*)arg) ->parameter);
WaitForSingleObject(file, INFINITE);
CTime tm = CTime::GetCurrentTime( );
m_Sec.Lock( );
int item = pList->InsertItem(pList->GetItemCount( ),
        ((Param*)arg)->message);
pList-> SetItemText (item, 1, tm.Format(“%Y/%m/%d
          − %H:%M:%S”));
m_Sec.Unlock( );
while (true)
  {
    FindNextChangeNotification(file);
    WaitForSingleObject(file, INFINITE);
    tm = CTime::GetCurrentTime( );
    m_Sec.Lock( );
    int item =
      pList->InsertItem(pList->GetItemCount( ),
        ((Param*)arg)->message);
      pList->SetItemText(item, 1,
      tm.Format(“%Y/%m/%d/ − %H:%M:%S”));
    m_Sec.Unlock( );
  }
```

A more detailed discussion of the process of spying on a file system under a Microsoft® Windows® operating system can be found at the following URL: http://www.codeguru.com/Cpp/W-P/files/article.php/c4467/

(b) Windows® Registry Hooking

The process of registry hooking under Microsoft® Windows® operating systems (e.g., Windows NT, 200 and XP) operates as follows. When a user-mode component makes a privileged system call, control is transferred to a software interrupt handler in NTOSKRNL.EXE (the core of the Windows NT operating system). This handler takes a system call number (which is passed in a machine register) and indexes to a system service table to find the address of the NT function that will handle the request. By replacing entries in the table with pointers to hooking functions, it is possible to intercept and replace, augment, or monitor NT system services. By spying on the Registry, the hooking process only hooks onto Registry-related services.

A more detailed description of the process of Windows® Registry hooking can be found in the function RegMon (a Windows utility that exploits the above technique to spy on the Registry) and at http://www.codeproject.com/system/hooksys.asp.

Alterations and modifications may be made to the above without departing from the scope of the invention.

1. A method of installing a software application on a recipient computer comprising the steps of:
(a) using an installation program to install the software application onto a donor computer;
(b) detecting one or more changes made to a registry of the donor computer during the installation of the software application thereon;
(c) detecting one or more changes made to a file system of the donor computer during the installation of the software application thereon;
(d) storing in a list, the changes made to the registry and the file system of the donor computer;
(e) removing from the list, one or more system variables that are specific to the donor computer;
(f) transmitting the list to the recipient computer;
(g) changing a registry of the recipient computer in accordance with the changes made to the donor computer's registry and stored in the list; and
(h) changing a file system of the recipient computer in accordance with the changes made to the donor computer's file system and stored in the list.

2. A method of installing a software application to a recipient computer as claimed in claim 1 comprising the further step (d1) of storing in the list one or more files added to the donor computer's file system.

3. A method of installing a software application to a recipient computer as claimed in claim 1 wherein one or more system variables that are specific to the donor computer are replaced in the list in step (e) with variables that are not specific to a particular computer.

4. A method of installing a software application to a recipient computer as claimed in claim 1 comprising the further step (d2) of storing in the list, a license number of the software application.

5. A method of installing a software application to a recipient computer as claimed in claim 1 comprising the further step (d3) of storing in the list, a license number of an installation manager of the software application.

6. A method of installing a software application to a recipient computer as claimed in claim 1 comprising the further step (d4) of storing in the list, files related to the software application.

7. A method of installing a software application to a recipient computer as claimed in claim 6 wherein the files related to the software application include library files, executable files and data files.

8. A system comprising means adapted for carrying out each step of the method according to claim 1.

9. A networked system comprising a shared file system resource and a plurality of computers connected thereto wherein the networked system comprises means adapted for carrying out each step of the method according to claim 1 and wherein the shared file system resource is the donor computer and the plurality of computers connected thereto are recipient computers.

10. A system as claimed in claim 9 wherein the donor and recipient computers employ the same version of the same operating system.

11. A computer program product stored on a medium readable by a computer machine, the computer program product tangibly embodying readable program means for causing the computer machine to perform the method according to claim 1.

12. A computer program product as claimed in claim 11 wherein the process of detecting changes made to the registry and the file system of the donor machine is performed by a spying daemon operating through a Win32 API.
